(19) United States
(12) Patent Application Publication
(10) Pub. No.: US 2024/0229551 A1
(43) Pub. Date: Jul. 11, 2024

(54) ROMAN SHADE

(71) Applicant: North Hills Home Inc., Manhasset, NY (US)

(72) Inventor: Huiqing SHOU, Manhasset, NY (US)

(73) Assignee: North Hills Home Inc., Manhasset, NY (US)

(21) Appl. No.: 18/094,173

(22) Filed: Jan. 6, 2023

(51) Int. Cl. E06B 9/264; E06B 9/262; E06B 9/38

(52) U.S. Cl. CPC E06B 9/264; E06B 9/262; E06B 9/38; E06B 2009/2622

(57) ABSTRACT

At least one embodiment comprises a shade having at least one front surface, at least one back surface, at least one catch formed on the back surface, at least one clasp, wherein said at least one claps is configured to selectively connect to said at least one catch. In at least one embodiment, the plurality of catches on the back surface of the shade. In at least one embodiment, the plurality of catches are comprised of loops. In at least one embodiment, the plurality of catches extend down each side of the at least one back surface of the shade. In at least one embodiment at least one rod extending substantially parallel to a horizontal plane when the shade is mounted. In at least one embodiment, the catch comprises at least one loop. In at least one embodiment, the shade further comprises a plurality of creases formed in the shade.

### BACKGROUND OF THE INVENTION

At least one embodiment of the invention comprises a window shade covering which is configured to be compacted based upon settings on the back devices. There is a need for a shade which is adjustable in height and which also can have a second layer, thereby forming a two layer shade. The two layer shade can be formed separate or it can be formed so that it is with the height adjustable elements.

### SUMMARY

At least one embodiment comprises a shade having at least one front surface, at least one back surface, at least one catch formed on the back surface, at least one clasp, wherein said at least one claps is configured to selectively connect to said at least one catch. In at least one embodiment, the plurality of catches on the back surface of the shade. In at least one embodiment, the plurality of catches are comprised of loops. In at least one embodiment, the plurality of catches extend down each side of the at least one back surface of the shade. In at least one embodiment at least one rod extending substantially parallel to a horizontal plane when the shade is mounted. In at least one embodiment, the catch comprises at least one loop. In at least one embodiment, the shade further comprises a plurality of creases formed in the shade. In at least one embodiment there are a plurality of creases and a plurality of rods, wherein there are at least two rods coupled to at least two creases on the shade. In at least one embodiment, there are a plurality of creases, wherein for each crease there is a rod, and wherein there are a plurality of catches, disposed above and adjacent to each crease, wherein each catch is configured to receive at least one clasp. In at least one embodiment the clasp is in the form of a clip. In at least one embodiment, the clasp is in the form of a tie comprising at least one cord.

### BRIEF DESCRIPTION OF THE DRAWINGS

Other objects and features of the present invention will become apparent from the following detailed description considered in connection with the accompanying drawings which disclose at least one embodiment of the present invention. It should be understood, however, that the drawings are designed for the purpose of illustration only and not as a definition of the limits of the invention.

In the drawings, wherein similar reference characters denote similar elements throughout the several views:

FIG. 1 is a back view of a first embodiment of a roman shade;

FIG. 2 is a back view of the embodiment of FIG. 1 in a first contracted position;

FIG. 3 is a back view of the embodiment of FIG. 1 in a second contracted position;

FIG. 4 is a back view of the embodiment of FIG. 1 with rods removed;

FIG. 5 is a front view of another embodiment;

FIG. 6 is a back view of the embodiment shown in FIG. 5; and

FIG. 7 is a back view of another embodiment which is a variation of the embodiment of FIG. 5;

FIG. 8 is a view of a telescoping rod for use with the embodiment of FIGS. 1-7;

FIG. 9 is a view of another embodiment which includes a double shade system;

FIG. 10 is a view of the double shade system of FIG. 9;

FIG. 11 is a first exploded view of the double shade system of FIG. 9;

FIG. 12 is a second exploded view of the double shade system as in claim 9;

FIG. 13 is a view of another embodiment having clips;

FIG. 14 is a view of the embodiment shown in FIG. 13;

FIG. 15 is an exploded view of the embodiment of FIG. 14;

FIG. 16 is another exploded view;

FIG. 17A is a side view of a clip used in the embodiments of FIGS. 13-16; and

FIG. 17B is a side view of another embodiment of a clip used in the embodiments of FIGS. 13-16.

### DETAILED DESCRIPTION

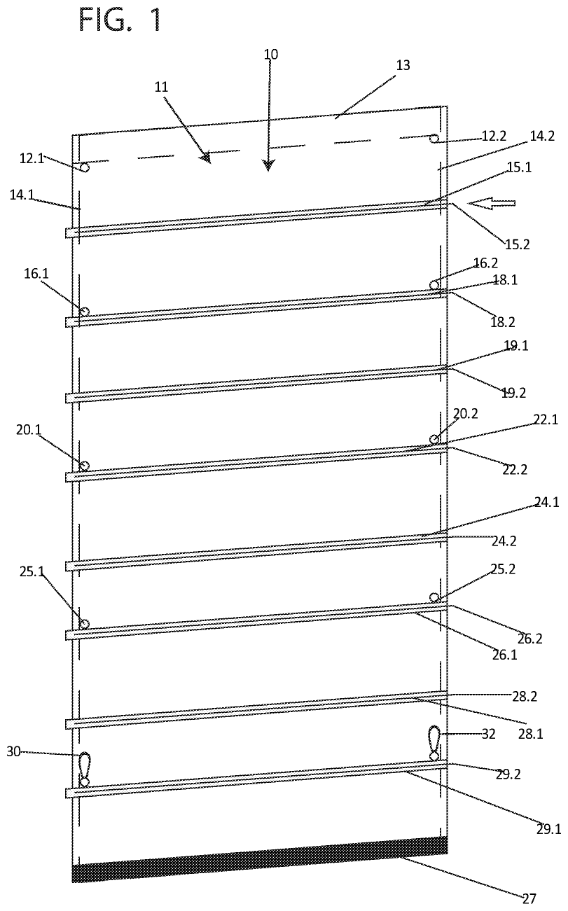

FIG. 1 is a back view of a first embodiment of a roman shade. For example, there is a shade 10 comprising back surface 11 which has a plurality of catches disposed thereon. In the top portion of the back surface 11 is a top area 13 which is in the form of a hemmed section. In addition, there are a plurality of catches 12.1 and 12.2 disposed on either side adjacent to the top area. The catches are in the form of rings or holes which are configured to receive a clasp such as clasp 30. There are also, runners 14.1 and 14.2 extending down the left and right side of this sheet. These runners 14.1 and 14.2 are configured to extend inside of the shade extending longitudinally down through the shade and which allow the shade to be selectively compressed using the clasps 30 and 32 coupling with respective catches such as catches 12.1 and 12.2. The runners 14.1 and 14.2 comprise lines or cords 14.1 and 14.2. There is also top crease 15.1 comprised of folded over shade material that is fastened together. The fastening of this material can be in the form of stitching, glue, adhesive, or any other suitable fastening means. The crease having a respective rod 15.2 disposed therein. Crease 15.1 is configured as a housing for rod 15.2. There are also additional clasps 16.1 and 16.2 which are disposed adjacent crease 18.1. Disposed inside crease 18.1 is a rod 18.2. These creases are formed by a fold over or flap formed in the shade, thereby forming a channel for housing a respective rod. There is another crease 19.1 housing another rod 19.2 spaced adjacent to and parallel to crease 18.1 and rod 18.2. In addition, catches 20.1, 20.2 are disposed adjacent to crease 22.1. Disposed inside crease 22.1 is rod 22.2. There is also another crease 24.1 housing rod 24.2. In addition, catches 25.1 and 25.2 are disposed adjacent to crease 26.1. Disposed inside crease 26.1 is rod 26.2. In addition, there is also additional crease 28.1 housing rod 28.2. Spaced opposite this crease 28.1 is an additional crease 29.1. Disposed inside crease 29.1 is rod 29.2. There also clasps 30 and 32 disposed adjacent to crease 29.1. In addition, there is also a bottom section 27 which is a weighted section which can include a rod or a weighted rod disposed therein. The rods may be made from wood, metal or plastic, and are configured to provide both a stiffening support for the shade as well as a weighted element configured to keep the shade substantially flat.

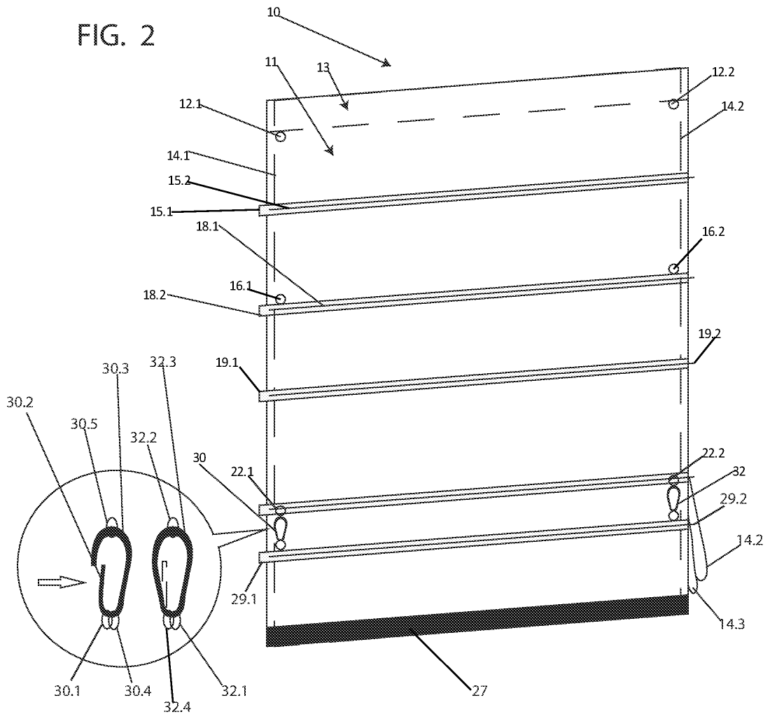

FIG. 2 is a back view of the embodiment of FIG. 1 in a first contracted position. For example, there is shown shade 10 having a back surface 11 having top area 13. Disposed adjacent to top area 13 are catches 12.1 and 12.2. Runners 14.1 and 14.2 extend longitudinally down the shade on either side of the shade. There is shown a top crease 15.1 having a rod 15.2. Catches 16.1 and 16.2 are shown adjacent crease 18.1. Crease 18.1 has additional rod 18.2. Crease 19.1 houses rod 19.2 while crease 29.1 houses rod 29.2. Clasps 30 and 32 are disposed adjacent to crease 29.1. Disposed inside of crease 29.1 is rod 29.2. These clasps 30 and 32 are shown positioned adjacent to or connected to catches 25.1 and 25.2. Thus, in this view the shade 10 is shown cinched up and shortened via the clasps 30 and 32 connecting with respective catches 25.1 and 25.2. There is shown a second line 14.2 and a third line 14.3 being cinched up, these lines are shown folded over and extending out from the shade 10.

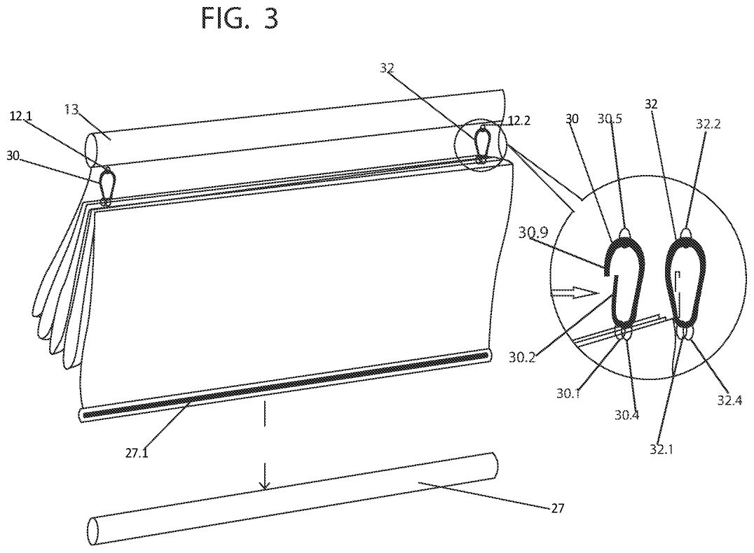

FIG. 3 is a back view of the embodiment of FIG. 1 in a second contracted position. In this view the embodiment includes a top section 13 with clasps 30 and 32 being clipped through respective catches 12.1 and 12.2 respectively. Clasps 30 and 32 are configured as teardrop or egg shaped loops which have a selectively openable portion. For example, the clasps 30 and 32 can be open selectively via a leaf springs such as the spring 30.2 on clasp 30 which is selectively closable against stop 30.9. There also rings 30.1 and 30.4 as well as ring 30.5 on clasps 30. Clasp 32 has rings 32.2, 32.1, and 32.4 as well. In addition, bottom section 27 shows rod 27.1 extending therein. The clasps 30 and 32 are selectively inserted into catches 12.1 and 12.22 thereby securing the clasps 30 and 32 to catches 12.1 and 12.2 respectively.

Rings 30.5 and 32.2 are configured to be attached to catches 12.1 and 12.2 respectively so that clasps 30 and 32 connect to these rings 30.5 and 32.2.

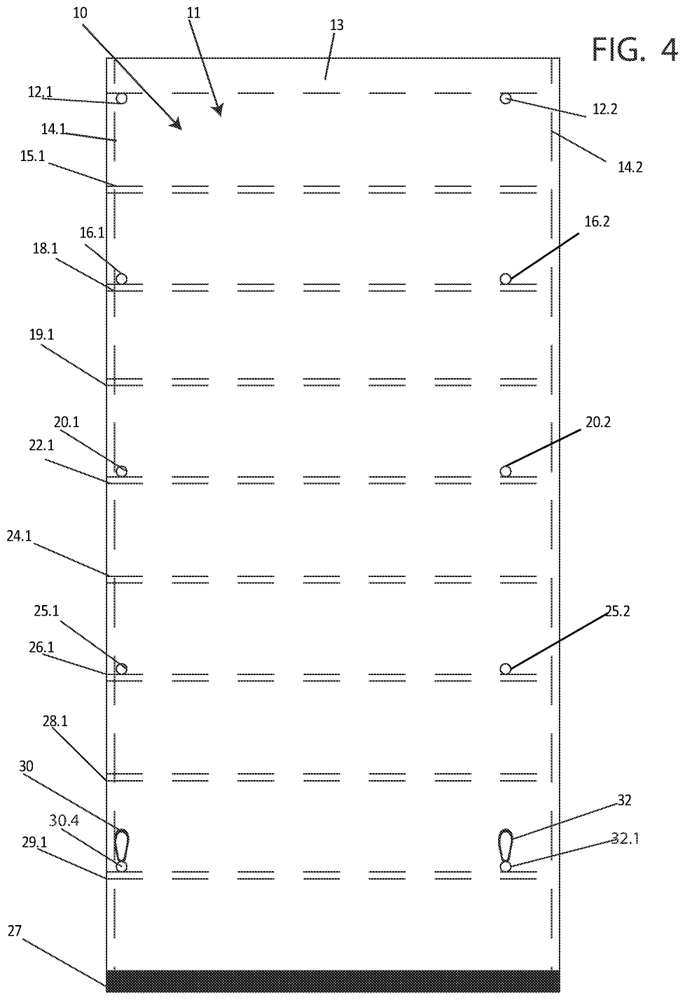

FIG. 4 is a back view of the embodiment of FIG. 1 with rods removed. For example, with this embodiment there is shown back surface 11 as well as top area 13 positioned adjacent to catches 12.1, 12.2. In addition, the plurality of lines 14.1 and 14.2 comprising a first line the second line respectively, each extend along the peripheral edges of this back surface. These lines 14.1 or 14.2 are configured to allow the shade to be retracted or cinched up. In addition, there are a plurality of creases formed in back surface 11 comprising first crease 15.1, a second crease 18.1, a third crease 19.1, a fourth crease 22.1, a fifth crease 24.1, a six crease 26.1, a seventh crease 28.1, and an eighth crease 29.1. This view also shows catches 16.1, 16.2, 20.1, 20.2, 25.1, 25.2, wherein these catches are configured to be coupled to associated clasps 30 and 32 to selectively raise or lower bottom section 27 off from a windowsill. There are also shown rings 30.4 and 32.1 configured to be coupled to clasps 30 and 32 respectively. These rings couple the clasps to the back surface 11 adjacent to a bottom area near crease 29.1. The catches 16.1, 16.2, 20.1, 20.2, 25.1, and 25.2 are in an alternating pattern associated with alternating creases 18.1, 22.1, 26.1, and 29.1.

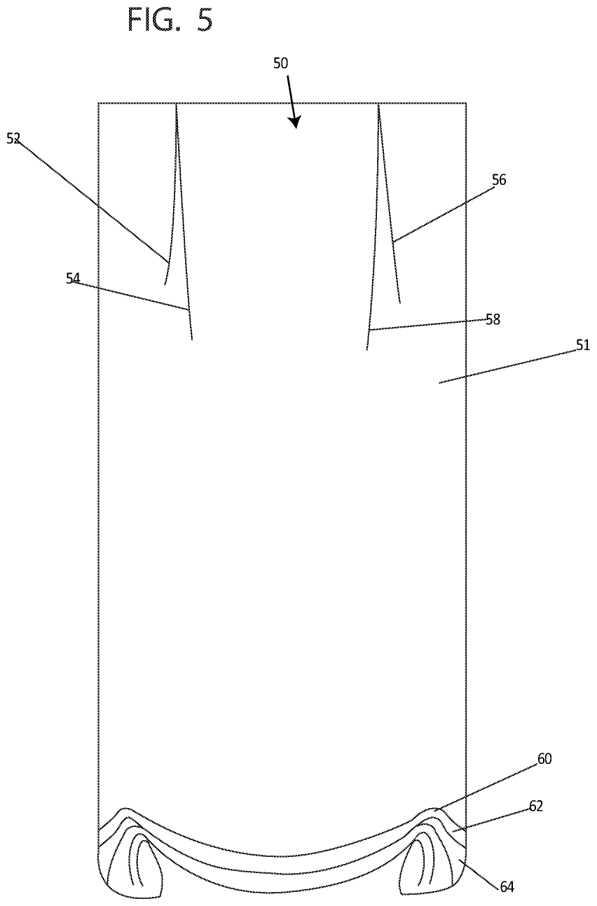

FIG. 5 is a front view of another embodiment. For example, there is shown another shade 50, which has a first cord 52 and a second cord 54. There also shown additional cords 56, and 58. This view shows the front surface 51 of the shade 50. In addition, towards a bottom area there is shown a series of folds 60, 62, and 64. These folds show that the screen can be selectively folded up in an artistic manner. This front view is created by clasps 30 and 32 (See FIG. 4) connecting to adjacent catches 25.1 and 25.2 (see FIG. 4). This connection causes the associated rod inside of these folds or creases to elevate or synch up a bottom portion of the shade so that the visible area or outer area of the shade is folded in this artistic manner.

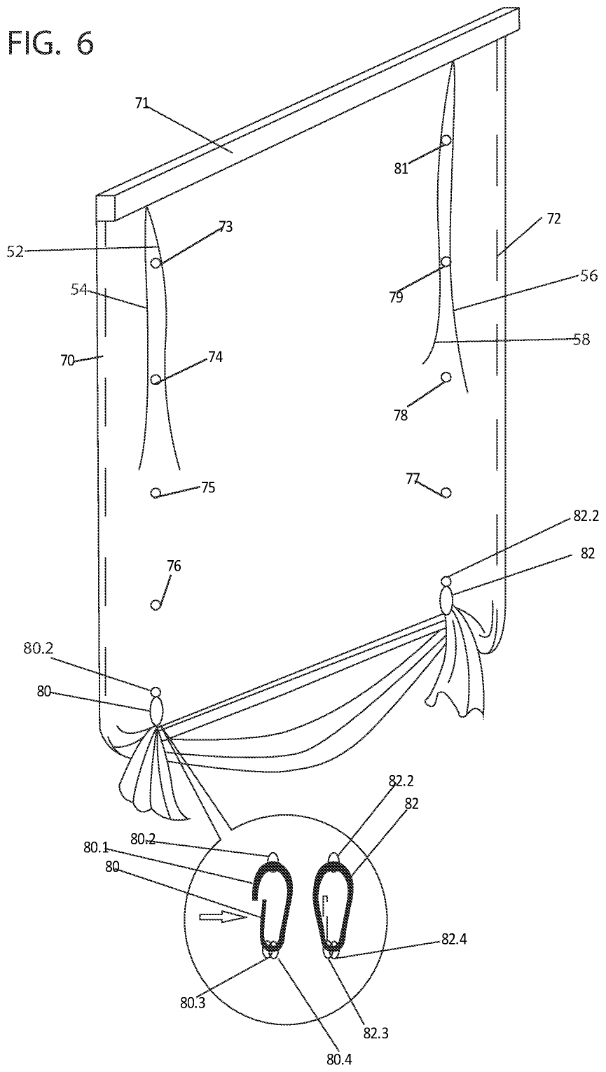

While the embodiments of FIGS. 1-4 can be used to provide the view of FIG. 5, FIG. 6 is a back view of another embodiment shown used to create the effect shown in FIG. 5. For example, there is a screen 70, having a back surface 69. Screen 70 has a top bracket 71, as well as first and second lines 72.1 and 72.2. There also of cords, including cord 52, cord 54, cord 56, and cord 58. This back surface 70 also includes a plurality of catches, including catch 73, 74, 75, and 76. There are also additional catches including catch 77, 78, 79, and catch 81. In addition, there are clasps 80 and 82 which include rings 80.2 and 82.2 respectively. There is also shown rod or bar 91. Clasps 80 and 82 include rings 80.2 and 82.2 respectively. Clasp 80 can be attached to cords 52 and 54 while clasp 82 can be attached to cords 56 and 58.

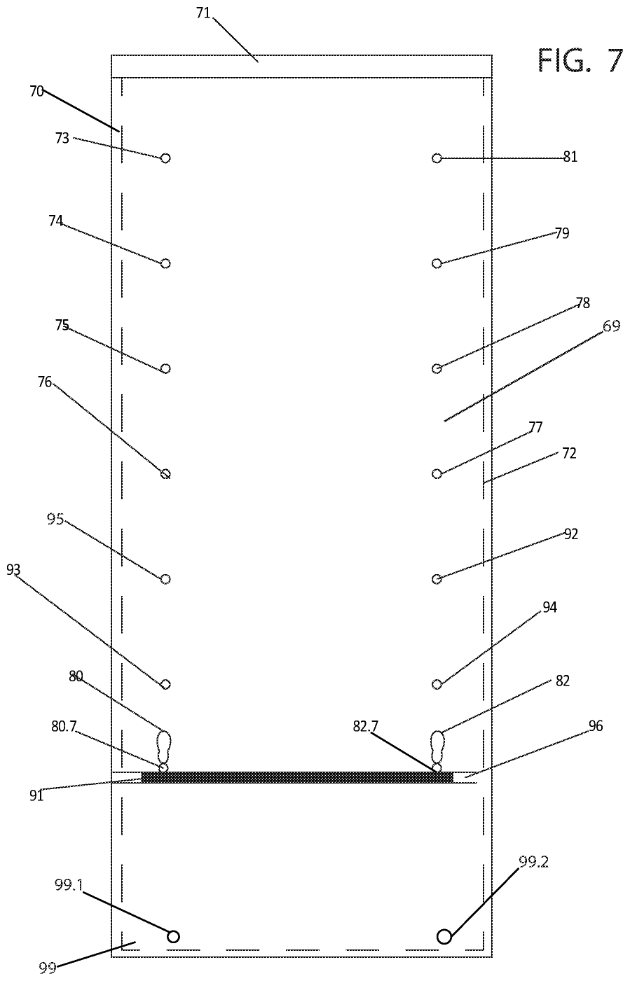

FIG. 7 is a back view of another embodiment which is a variation of the embodiment of FIG. 5. In this view there is shown a back surface 70 with a plurality of catches 73, 74, 75, 76, 93, 95, 77, 78, 79, 81, 93, 94. There are also clasps 80 and 82 as well as connectors or rings 80.7 and 82.7. There is also a rod or a bar 91 which is insertable into a slot 96. There are also shown catches 99.1 and 99.2 which can be connected to clasps 80 and 82 respectively wherein when these catches 99.1 and 99.2 are connected to clasps 80 and 82 this creates the effect shown in FIGS. 5 and 6.

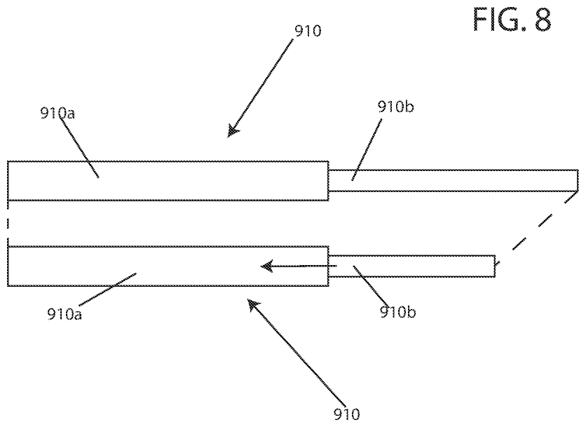

FIG. 8 is a view of a rod 910 wherein this rod is a telescoping rod having a first section rod 910a and a second section or rod 910b. The first section rod 910a has a larger inner diameter than the other diameter of rod 910b so that rod 910b slides within rod 910a. Thus, this telescoping rod is configured to slide into slot 96 of any suitable shade of any suitable width due to its extendable nature.

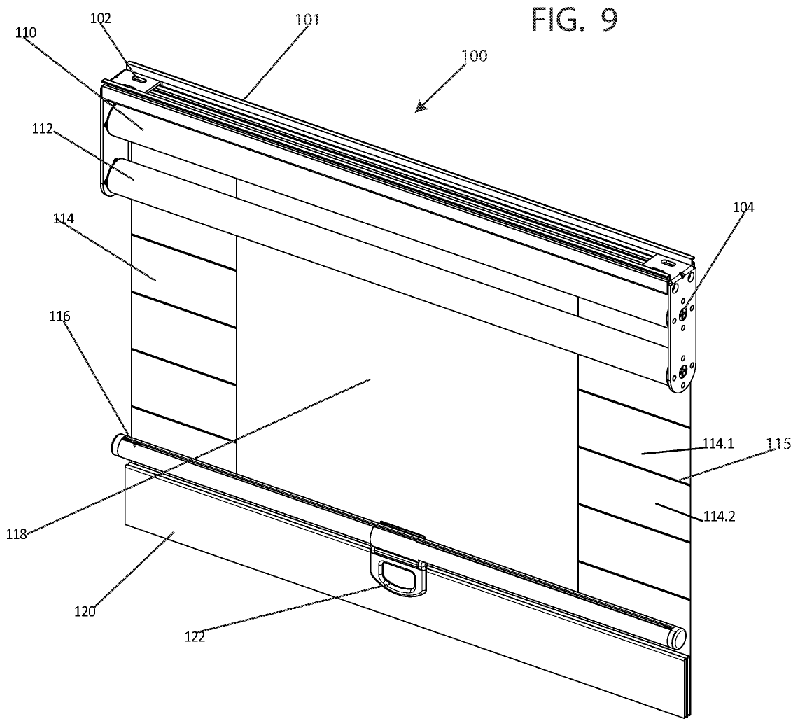

FIG. 9 is a double shade design 100 which includes brackets 102 and 104 as well as a frame or bracket 101 coupling the brackets together. There is a first shade 110 and a second shade 112 coupled to each of these brackets. First shade 110 is shown having a first shade end 116. Coupled to the first shade end is a first shade handle 122 as well.

This shade system includes a frame 114 which extends down from frame section or bracket 101. This frame 114 includes side walls and a central region forming a screen such as a translucent screen or a shade 118 which can alternately be an opening or a clear region for viewing out a window. There is also a bottom section 120 of this frame as well. This bottom section can include a folded over section which can be extended lower by folding down via another level. This frame section includes folds or creases 115 which allow the frame to be extended vertically up or down by folding the frame into each of the creases.

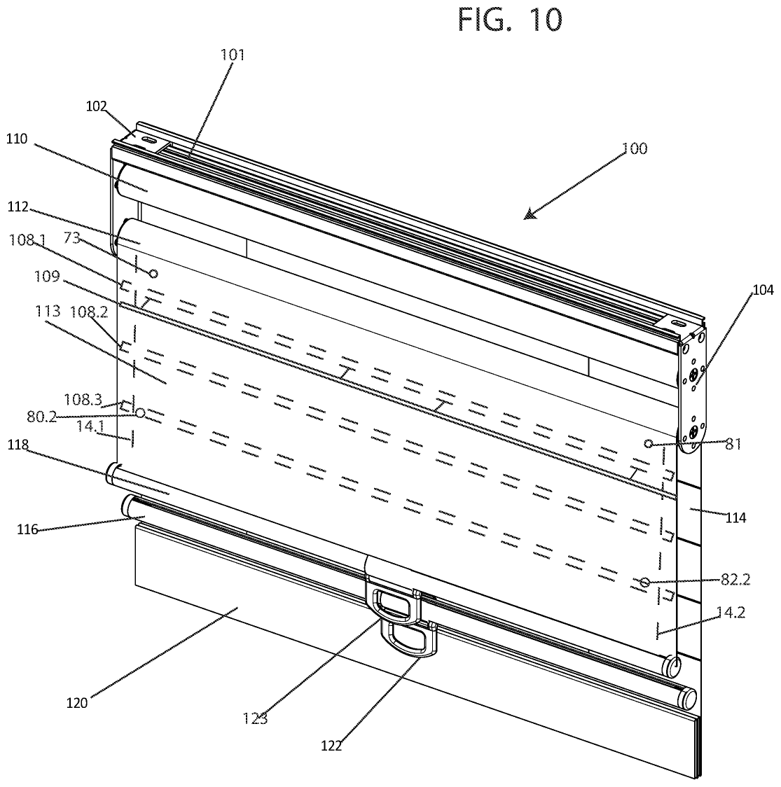

FIG. 10 is another view of this embodiment 100 which shows second shade 112 being pulled down to second shade body 113. Second shade body 113 extends down into second shade end 117. Second shade end has handle 123 which is similar to handle 122 on the first shade. First handle 122 is coupled to first shade end 116. Bracket or frame 114 is also shown coupled to bracket 101. Frame 114 has bottom end 120 shown adjacent to the handles. In addition, there is also shown brackets 102 and 104 coupled to bracket 101.

Frame 114 comprises a plurality of sections 114.1 and 114.2 and a plurality of creases 115, wherein each of said plurality of sections are foldable over each of said plurality of creases 115 to make the frame selectively extendable in length. The frame 114 is made of any suitable material for a shade but in at least one embodiment is a stiffened cloth material that can be folded along creases 115. In this view there is also shown slots 108.1, 108.2, and 108.3 which are parallel to each other and spaced apart from each other along the inside surface of the shade as well as a rod 109 which can be selectively inserted into any one of slots 108.1, 108.2, and 108.3. This rod provides for the straightening of the surface of the shade so that it is seen as a relatively flat surface. Accordingly, multiple rods can be fit into multiple different slots 108.1, 108.2, 108.3. There are also lines 14.1 and 14.2 as well as catches 73 and 81 allowing the blind to be retracted.

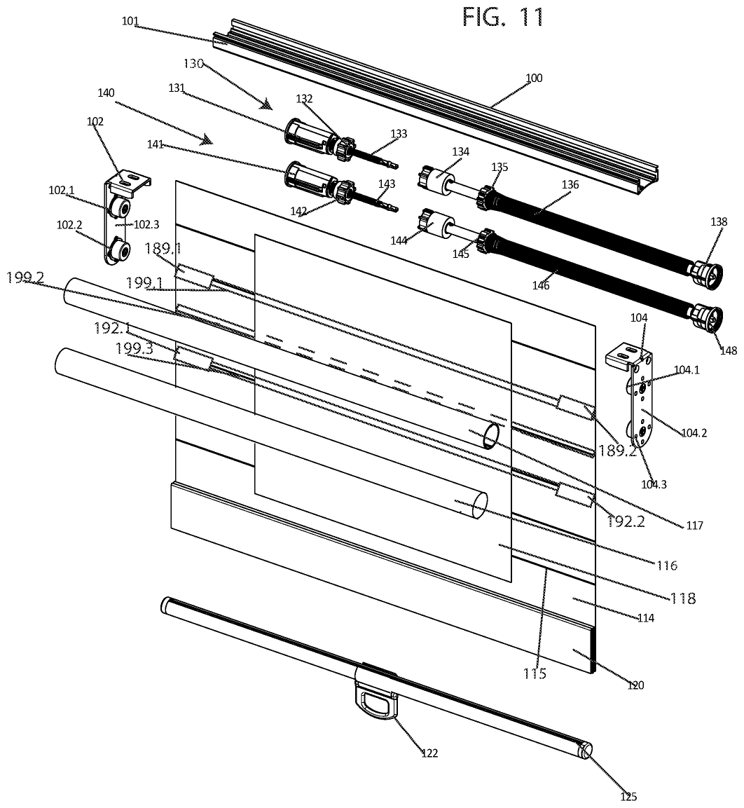

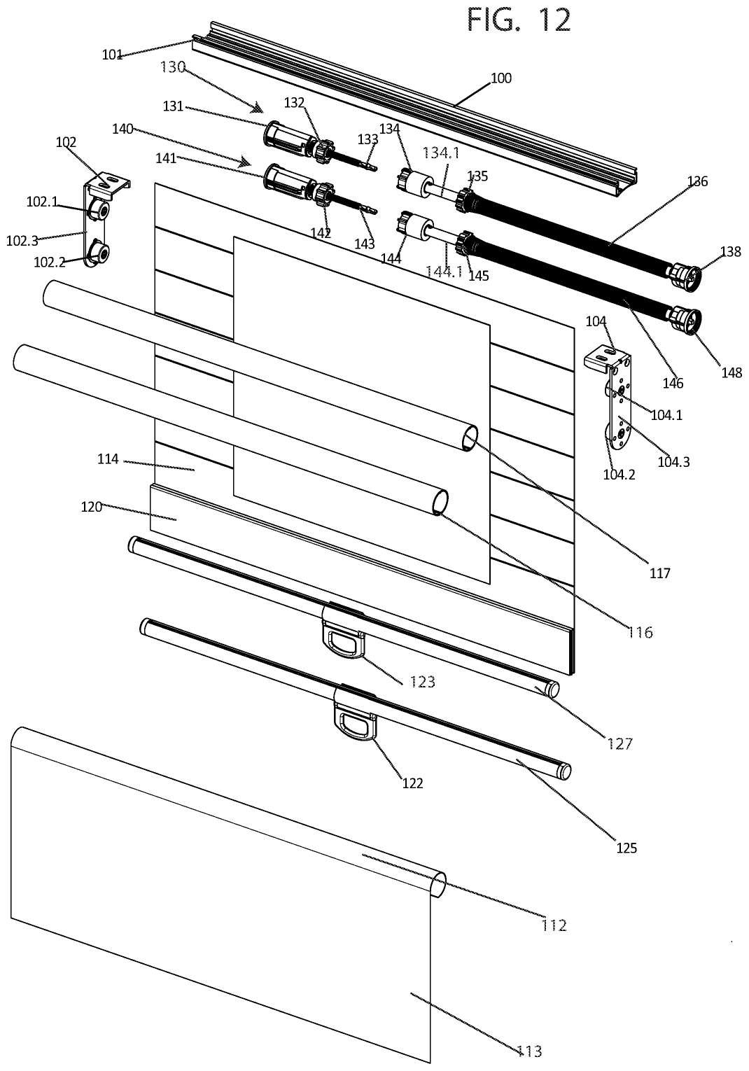

FIGS. 11 and 12 are exploded views of the embodiment shown in FIGS. 9 and 10. For example, in these views there is shown with embodiment 100 a bracket 101 which is a substantially U-shaped upper bracket, as well as two drive mechanisms 130 and 140. Drive mechanism 130 includes a first drive end 131 with a first gear 132 positioned adjacent to the first drive end 131. There is a rod 133 extending out from end gear 132. There is another gear 134 which is configured to be coupled to first gear 132 so that these two gears can selectively mesh together. Coupled to gear 134 is a telescoping rod 134.1 which selectively slides within the body of the rod 136 of the first shade. Another gear 135 is positioned adjacent to gear 134 wherein this gear is positioned adjacent to rod 136 of the first shade. There is also an end 138 of the first shade rod, wherein ends 131 and 138 fit into bracket connectors 102.1 and 104.1 respectively in a rotatable manner allowing the first shade to be selectively unfurled or closed up. There is also shown rods 199.1, 199.2, and 199.3. Rods 199.1 and 199.3 each have pockets disposed on either side of them. For example, rod 199.1 has pockets 189.1 and 189.2 disposed on either side of rod 199.1. In addition, rod 199.3 has pockets 192.1 and 192.2 disposed on either side of rod 199.3 to lock rod 199.3 therein. However rod 199.2 does not have pockets on either side but rather is tucked inside of sheet or screen 114.1 as shown by the dashed dotted lines, thereby providing stiffening support between the frame 114 and the screen 118. Frame 114 is in at least one embodiment formed from a stiffened fabric material with a plurality of creases disposed therein these creases are creases 115 shown between sections 14.1 and 14.2 (see FIG. 9).

In addition, drive mechanism 140 includes a first drive end 141 with a first gear 142 positioned adjacent to the first drive end 141. There is a rod 143 extending out from first gear 142. There is another gear 144 which is configured to be coupled to first gear 142 so that these two gears can selectively mesh together. Coupled to gear 144 is a telescoping rod 144.1 which selectively slides within the body of the rod 146 of the second shade. Another gear 145 is positioned adjacent to gear 144 wherein this gear is positioned adjacent to rod 146 of the first shade. There is also an end 148 of the first shade rod, wherein ends 141 and 148 fit into bracket connectors 102.2 and 104.2 respectively in a rotatable manner allowing the first shade to be selectively unfurled or closed up.

In addition, in this view bracket or frame 114 is shown with bottom end 120 as well as ends 116 and 117. There is also shown a first inner shade end 125 as well as a second inner shade end 127 wherein these shade ends are coupled to handles 122 and 123 respectively. In addition, as shown in FIG. 12 there is shown second shade roll 112 which when unfurled has second shade body 113.

With this design each of the shades 110 and 112 can include the shade of FIG. 7 having a plurality of catches 73, 74, 75, 76, 93, 95, 77, 78, 79, 81, 93, 94. There are also clasps 80 and 82 as well as connectors or rings 80.7 and 82.7. There is also a rod or a bar 91 which is insertable into a slot 96.

The two-layer shade system allows for shades of differing opacity to be used to either shield visibility without restraining too much light while another shade such as a second shade can be in the form of a completely solid shade which forms a blackout shade. Each of these shades is configured to work with a frame such as frame 114 which is adjustable in length so that it can be selectively unfolded along crease lines 115 to extend the extension of this frame 114.

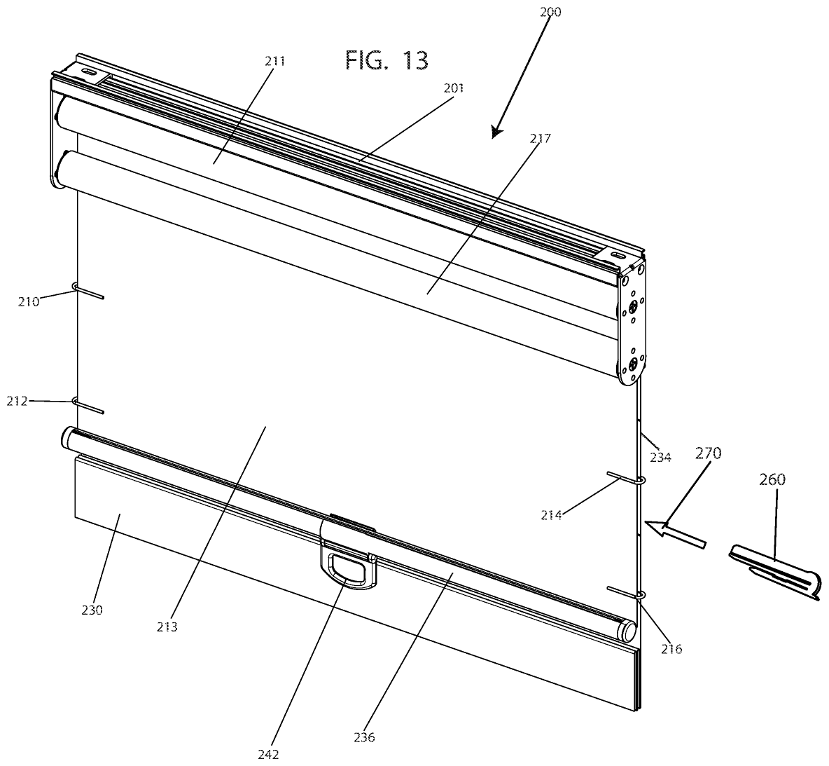

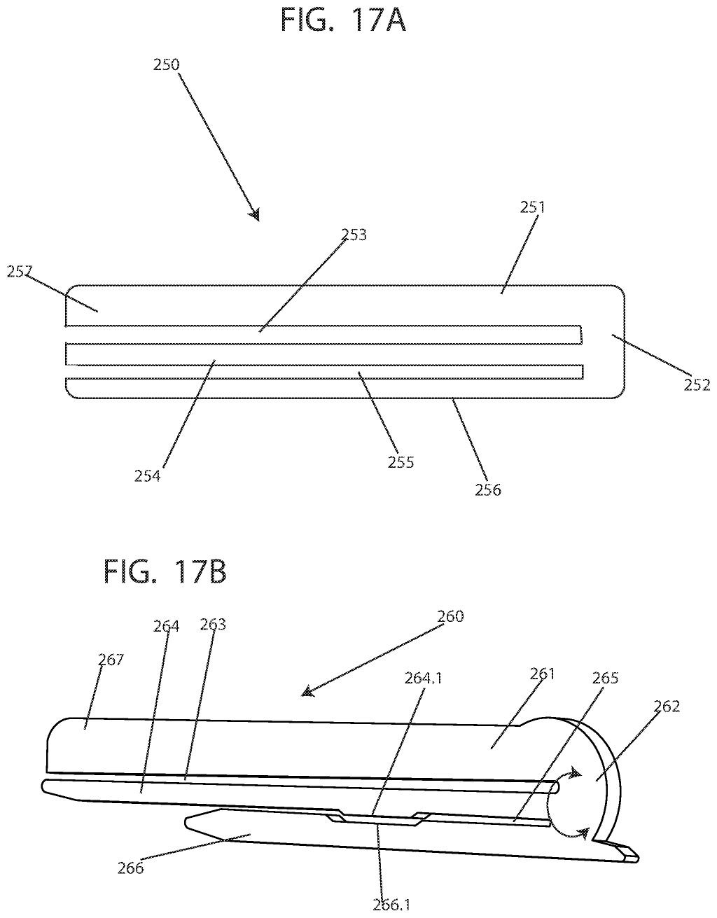

FIG. 13 is a view of another embodiment of a multi shade system 200 wherein this view shows a bracket 201, a first shade 211, a second shade 217 as well as clips 210, 212, on one side as well as clips 214 and 216 on the right side. There is a body portion 213 of the first shade 211 which is shown extending down to bottom section 236 which is substantially tubular in shape. A handle 242 is coupled to this bottom section 236. There is also bottom portion 230 shown which is part of a frame for supporting the multi-shade system 200. Shown in this view is a clip 260 (See FIG. 17B) which can be used in the place of any one of clips 210, 212, 214, 215, 216, and 218. The arrow 270 shows that this clip can be attached to the system by being slid onto the shades and the frame to couple the shades and the frame together.

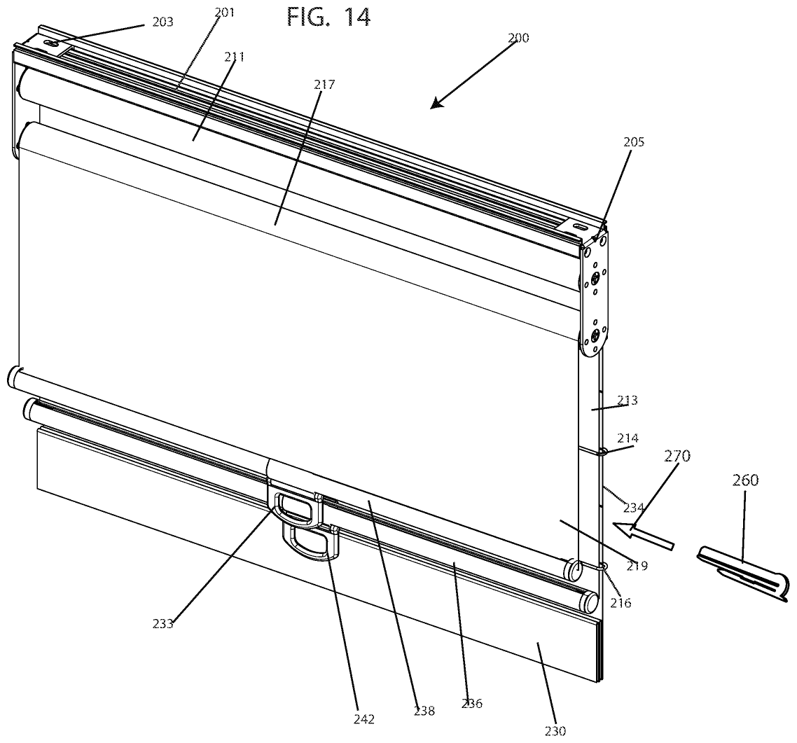

FIG. 14 is a perspective view of the embodiment of FIG. 13. With this view there is shown brackets 201, 203 and 205 which are coupled together to hold shades 211 and 217 as well as frame 234. Shade 211 has a shade body 213 while shade 217 has a shade body 219. There are clips 214 and 216 which are shown clipping screen body 213 to frame 234. These clips 214 and 216 are positioned on the right-hand side of the frame and the shades and is configured as substantially U-shaped and is configured to clip the shade body 213 with the frame 234. Shade 217 has a shade bottom 238, while shade 211 has a shade bottom 236. Shade bottom 238 has a handle 233 while shade bottom 236 has a handle 242. Frame 234 has a frame bottom 230 which is formed from folded over sections of the frame 234 along crease lines. This view also shows clip 260 as well as arrow 270 which shows that clip 260 can be used in the place of any one of clips 210, 212, 214, 215, 216, and 218. The arrow 270 shows that this clip can be attached to the system by being slid onto the shades and the frame to couple the shades and the frame together.

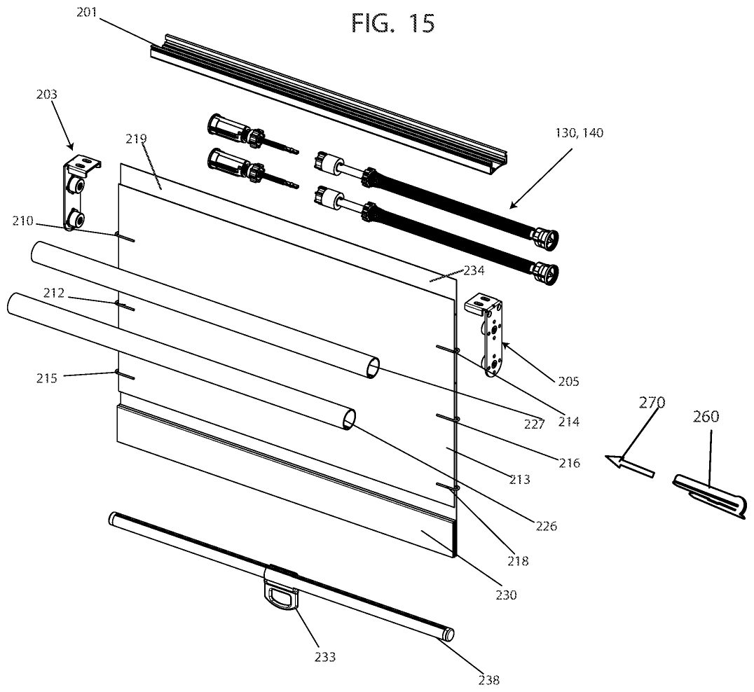

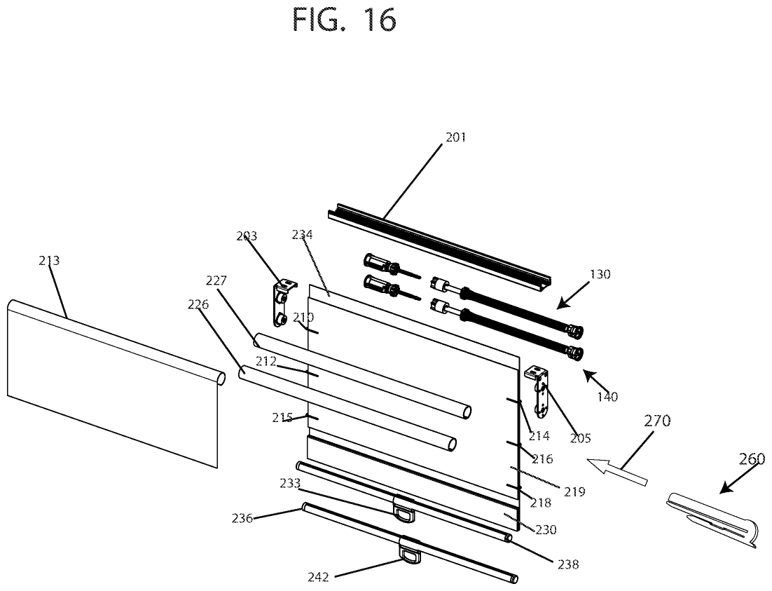

FIGS. 15 and 16 are an exploded view of the double shade system with clips. In this view there is an exploded view which shows frame or bracket 201 and frame or bracket 203 and 205 which are coupled each other when the device is assembled. Drive mechanisms 130 and 140 are configured to be used with driving the different shades. There is also shown frame 234 which sits behind screen body 213. The screen body 219 is configured to be coupled to frame 234 via clips 210, 212, and 215 on a left-hand side of the screen. On the right-hand side there are clips 214, 216, and 218 which are configured to couple the screen to the frame 234 as well. These clips can also be used to couple to two different screens together as well. Thus, the clips 210, 212, and 215, as well as the clips 214, 216, and 218 are configured to clip the screen bodies 213 and 219 together as well as the screens 213 and 219 to the frame 234 as well. In addition, in these exploded views there is shown tubes 226 and 227 which are configured to receive screen bodies 213 and 219 to form the screens or shades 213 and 219. This view also shows clip 260 as well as arrow 270 which shows that clip 260 can be used in the place of any one of clips 210, 212, 214, 215, 216, and 218. The arrow 270 shows that this clip can be attached to the system by being slid onto the shades and the frame to couple the shades and the frame together.

FIG. 17A is a side view of a clip 250 wherein this clip is representative of clips 210, 212, 215, 214, 216, and 218. Clip 250 has a clip body 251 which has a plurality of fingers which include fingers 257, 254, and 256 which are coupled together via a backing or back frame section 252. There are gaps 253 and 255 such that gap 253 is positioned between finger 257, and 254, while gap 255 is positioned between finger 254 and 256. The shade bodies 213 and 219 are configured to be fit inside of gaps 253 and 255, also frame 234 is configured to fit into one of these gaps 253, and 255 so that the screens or screen bodies can be coupled together and also coupled to the frame 234 as well. These clips can be formed from any suitable material such as from a metal, plastic, wood, composite or any other suitable material. The fingers can be separated via the flexibility of the fingers 257, 254, and 256 bending around frame section 252.

FIG. 17B shows clip 260 wherein clip 260 is shown as having a body section 261, a first finger 267, a back 262 and a first gap 263. There is a second finger 264 which has a protrusion 264.1 coupled to back 262. Another gap 265 is positioned between finger 264 and finger 266. Finger 266 has an indented region 266.1 which is configured to receive protrusion 264.1. There is a gap between protrusion 264.1 and indented region 266.1. This indented region 266.1 and associated protrusion 264.1 are configured to selectively secure these screens in a friction fit manner either to each other or to an associated frame. For example, these fingers 267, 264 and 266 are bendable about an axis (see arrow) on back or base 262 so that the gaps 263 and 265 can be selectively enlarged to receive screens or backings or brackets. This allows screens or screen sheets 213 and 219 to be slid into these gaps and then either coupled together or coupled to an associated bracket or frame 234. This makes the double screen design a neat and configurable screen system.

Thus, there is created a screen and frame system which is designed to be universally adjustable as well as suitable via both the multiple screens and frames, in an organized manner.

Accordingly, while at least one embodiment of the present invention have been shown and described, it is to be understood that many changes and modifications may be made thereunto without departing from the spirit and scope of the invention as defined in the appended claims.

What is claimed is:

1. A shade comprising:
a) at least one front surface;
b) at least one back surface;
c) at least one catch formed on the back surface; and
d) at least one clasp, wherein said at least one claps is configured to selectively connect to said at least one catch.

2. The shade as in claim 1, wherein there are a plurality of catches on the back surface of the shade.

3. The shade as in claim 1, wherein the plurality of catches are comprised of loops.

4. The shade as in claim 1, wherein the plurality of catches extend down each side of the at least one back surface of the shade.

5. The shade as in claim 1, further comprising at least one rod extending substantially parallel to a horizontal plane when the shade is mounted.

6. The shade as in claim 1, wherein said at least one catch comprises at least one loop.

7. The shade as in claim 1, wherein the shade further comprises a plurality of creases formed in the shade.

8. The shade as in claim 1, further comprising a plurality of creases and a plurality of rods, wherein there are at least two rods coupled to at least two creases on the shade.

9. The shade as in claim 1, further comprising a plurality of creases, wherein for each crease there is a rod, and wherein there are a plurality of catches, disposed above and adjacent to each crease, wherein each catch is configured to receive at least one clasp.

10. The shade as in claim 1, wherein the clasp is in the form of a clip.

11. The shade as in claim 1, wherein the clasp is in the form of a tie comprising at least one cord.

12. A double shade system comprising:
at least one frame;
at least one first shade coupled to said at least one frame; and
at least one second shade coupled to said at least one frame, wherein said at least one second shade is configured to extend adjacent to said at least one first shade.

13. The double shade system as in claim 12, wherein said at least one frame further comprises a plurality of brackets wherein said plurality of brackets are configured to receive said at least one first shade and said at least one second shade.

14. The double shade system as in claim 12, wherein said at least one frame comprises a plurality of sections and a plurality of creases, wherein each of said plurality of sections are foldable over each of said plurality of creases to make the frame selectively extendable in length.

15. The double shade system as in claim 12, wherein at least one shade of said at least one first shade and said at least one second shade comprises a drive mechanism.

16. The double shade system as in claim 12, wherein at least one shade of said at least one first shade and said at least one second shade comprises at least one catch and at least one clasp.

17. The double shade system as in claim 16, wherein the plurality of catches comprise loops.

18. A shade system comprising:
at least one frame comprising:
a first frame body section;
at least one second frame body section;
at least one crease formed between the first frame body section and the second frame body section;
a plurality of brackets;
a first shade;
a second shade, wherein said first shade and said second shade are rotatably coupled to said plurality of brackets, and wherein at least said first shade has a plurality of catches and at least one clasp so that at least one clasp is selectively attachable to at least one of said at least one catch so that at least one first shade is selectively extendable in length; and
at least one clip, said at least one clip configured to couple said first shade and said second shade together.

19. The shade system as in claim 18, wherein said at least one second shade has a plurality of catches and at least one clasp so that at least one clasp is selectively attachable to at least one of said at least one catch so that said second shade is selectively extendable in length.

20. The shade system as in claim 19, wherein said at least one first shade and said at least one second shade each have drive mechanisms wherein each of the drive mechanisms have gears.
